(19) United States
(12) Patent Application Publication
(10) Pub. No.: US 2014/0373064 A1
(43) Pub. Date: Dec. 18, 2014

(54) Method and Systems for Tiered Navigational Guide Creation

(71) Applicant: Concurrent Computers Corporation, Duluth, GA (US)

(72) Inventor: David L. Ray, Alpharetta, GA (US)

(21) Appl. No.: 13/918,292

(22) Filed: Jun. 14, 2013

(51) Int. Cl. H04N 21/258; H04N 21/262

(52) U.S. Cl. CPC H04N 21/25891; H04N 21/26283
USPC 725/46

(57) ABSTRACT

A method and system are provided. A server (110) can include a control circuit (127) in communication with a client device (106). The control circuit can deliver a universal program guide (114) to the client device, the universal program guide comprising a plurality of predefined tiers. The control circuit can monitor a navigation path through at least two of the predefined tiers. The control circuit can determine a navigation duration occurring at each tier. The control circuit can create a unique program guide from the navigation path and the navigation duration. The control circuit can deliver the unique program guide to the client device for subsequent presentation.

### BACKGROUND

1. Technical Field

This disclosure relates generally to programming guides, and more particularly to program guide creation.

2. Background Art

When consuming video or audio content from a service provider, a consumer must navigate through layers and layers of menus. This process can be tedious, as each layer can include a plurality of selectable options. The “layers” of complicated menus are frequently organized in a hierarchy, with top-level menus leading to lower level menus, and so forth. The lower level menus frequently include additional detail not available at higher levels.

A problem associated with these complex menus is that it can be tedious to find a particular selection. A user may have to navigate through several menus to find a particular selection. Additionally, if a user does not know the exact content for which they are searching, sometimes they are unable to find a particular selection due to the complexity of layers.

It would be advantageous to have an improved system for menu creation.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system configured in accordance with one or more embodiments of the disclosure.

FIG. 2 illustrates an explanatory method configured in accordance with one or more embodiments of the disclosure.

FIG. 3 illustrates an explanatory method configured in accordance with one or more embodiments of the disclosure.

FIG. 4 illustrates an example of a tiered program guide configured in accordance with one or more embodiments of the disclosure.

FIG. 5 illustrates another explanatory tiered program guide configured in accordance with one or more embodiments of the disclosure.

FIG. 6 illustrates another explanatory tiered program guide configured in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to navigational program guide modification and creation. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of program guide delivery, navigation monitoring, and program guide creation and customization as described herein. The non-processor circuits may include, but are not limited to network communication devices, routers, switches, video compression and decompression engines, and user devices. As such, these functions may be interpreted as steps of a method to perform program guide delivery, creation, modification, and navigational monitoring. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in a figure other than figure A.

As noted above, problems exist with complex program guides. While they are tricky for users, they also present problems for purveyors of program guides. One such problem is that it is difficult to monitor customer interactions with the menu to determine the efficacy of the menu's organization or the types of selections users tend to make. While there are methods for monitoring “clicks” on websites or through online catalogs, these prior art systems require large amounts of data acquisition as each and every click is tracked. This large amount of data acquisition that is required precludes “click tracking” systems from being used due to the high processing power that is required. Accordingly, such systems cannot be employed, for example, in video on demand (VOD) systems.

When using video on demand systems, experimental testing has shown there are three basic interaction environments consumers use in interacting with the systems. These three environments are as follows:

Navigation through a hierarchical menu of choices for selection of a video on demand asset to be played;

Selection and possible purchase of a video on demand asset; and

Playout of the selected video on demand asset and control over the playout.

Conventional software tools are available to acquire data from the latter two classes. The data collected enables service providers to promote and price video on demand assets for maximum revenue. However, the collected data fails to identify the path the consumer traversed to get to the asset, or whether other assets were considered prior to purchase.

Embodiments of the disclosure provide a solution to this issue. In one embodiment, a system provides a simplified program guide environment in a hosted video on demand system. In one embodiment, a navigation data monitor operable with a server records the occurrence of navigation events executed by a user. These navigation events are indicated by signals received from a navigation interface at a client device. A navigation event aggregator in the server then aggregates the data collected by the navigation data monitor. In effect, the navigation data monitor monitors user navigation of tiered program guides at the server. The monitoring is performed in real time in one embodiment. The navigation data monitor can be configured to observe the user's navigation through a series of program guide tiers, and to capture each user action.

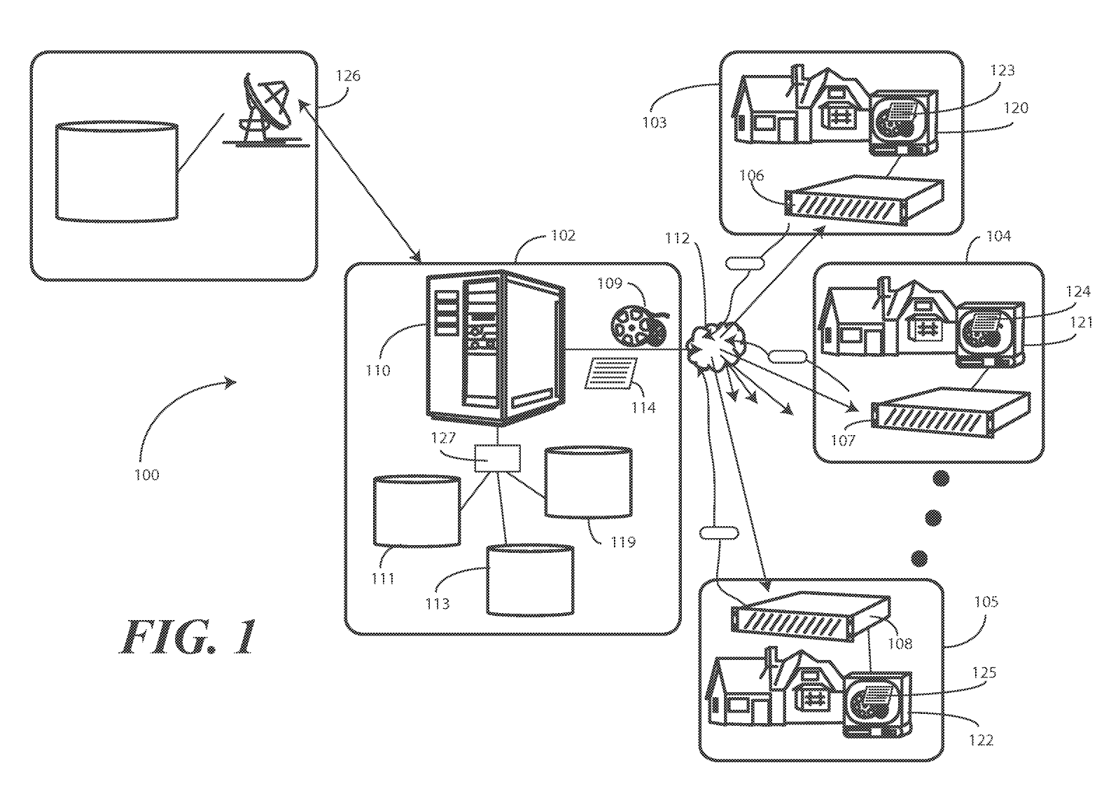

Turning now to FIG. 1, illustrated therein is one embodiment of a system 100 configured in accordance with one or more embodiments of the disclosure. The system 100 of FIG. 1 is configured for delivering one or more program guides to one or more users 103,104,105. FIG. 1 illustrates a macro-level view of the system 100, while more detailed structures will be described in more detail later. The system 100 of FIG. 1 is suitable for implementing the methods of providing programming guides, such as a universal video on demand program guide or a user-specific program guide to a client device as described in the subsequent figures.

Each of the users 103,104,105 in this explanatory embodiment has a corresponding client device 106,107,108 configured to receive content and program guides. Examples of client devices 106,107,108 occurring in various environments include a television, set-top-box, personal computer, laptop, smartphone, tablet computer, personal digital assistant, handheld computer, cellular telephone, or the like.

In one illustrative embodiment, the server complex 102 is capable of interaction with the client devices 106,107,108. For example, the server complex 102 may be configured to determine what content each client device 106,107,108 is receiving, what programming guide 123,124,125 each client device 106,107,108 is receiving, and how each user 103,104,105 is navigating through that programming guide 123,124,125. Additionally, the server complex 102 can be configured to determine a unique device identifier for each of the client devices 106,107,108 so that the client devices 106,107,108 can be identified on a singular basis. Examples of device identifiers include a MAC address or IP address in a computer environment, a mobile telephone number in a mobile environment, a serial number or other unique identifier in a set-top box environment, and so forth.

In one embodiment, the system 100 is configured for delivering program guides 123,124,125 to the client devices 106,107,108 corresponding to the one or more users 103,104,105. The program guides 123,124,125 can be sent across the interactive network 112 by way of network equipment that provides the managing, processing, and modulation, as appropriate, for the delivery of the program guides 123,124,125 across the interactive network 112 to the client devices 106,107,108.

The interactive network 112 may be any type of network capable of transferring data electronically, such as, but not limited to, cable networks, the Internet, wireless networks, Telco networks, or satellite networks. For ease of explanation, an illustrative embodiment will employ a cable network. However, it will be clear to those of ordinary skill in the art having the benefit of this disclosure that embodiments are not so limited. Other networks can be used as well.

The program guides 123,124,125 can be universal, user-specific, or combinations thereof. Where universal, a single program guide, e.g., universal program guide 114, is for delivery to all users 103,104,105. Where user-specific, a selected program guide, e.g., program guide 123, is for delivery to only a single user, e.g., user 103.

In one or more embodiments, a universal program guide 114 is initially delivered to client devices 106,107,108. In one embodiment, the universal or predefined program guide comprises a plurality of tiers. This “tiered guide” is sometimes referred to as a hierarchical guide, as it includes many different tiers, levels, or layers.

A server 110 of the server complex 102 can then monitor a navigation path of the users 103,104,105 on their client devices 106,107,108 through at least some of the plurality of selection tiers. The server 110 can also, in one embodiment, monitor navigation duration at each tier selected by each user 103,104,105. In one embodiment the server 110 can create a user-specific program guide, e.g., program guide 123 as a function of the navigation path and the navigation duration. The server 110 can then deliver the user-specific program guide to the client device during a next user interaction with the client device.

The server complex 102 may receive data in a variety of formats, including RF signals by satellite, ATM data from ATM networks, local feeds, and other information via terrestrial link. Where necessary, the server complex 102 can optionally process and/or reformat the data as necessary for delivery to the client devices 106,107,108. For example, the various program guides 123,124,125 and/or corresponding content may be prepared in a digitally compressed format, demultiplexed by a demultiplexer, and stored in any convenient format or formats, such as MPEG-1, MPEG-2, or MPEG-4. It will be clear to those of ordinary skill in the art having the benefit of this disclosure that other formats can be used as well. Such formats are known in the art and will not be discussed in further detail here in the interest of brevity.

In one embodiment, the server 110 is able to determine navigation through the various programming guides 123,124,125 to acquire a variety of data. For example, using a video on demand environment for illustrative purposes, in one embodiment the server 110 can identify which video on demand assets 109 were or were not selected by the users 103,104,105. In addition, the server 110 can determine a “trail of history” regarding which video on demand assets 109, or collections of assets, were considered by the users 103,104,105 during the program guide navigation experience. Acquisition of this navigational trail data allows third parties, such as the purveyor of the server complex 102 and/or navigation data consumer 126, to understand better how the users 103,104,105 arrived at the points of decision for selection or rejection of particular video on demand assets 109. Additionally, the navigational trail data can be used by the server complex 102, the purveyor of the server complex 102, or others. With this level of cognizance, these third parties can adjust the hierarchical structure of program guides 123,124,125, either manually or in an automated manner, to better promote underutilized video on demand assets and to direct users 103,104,105 towards particular tiers within the program guides 123,124,125.

In one illustrative embodiment, the each client device 106,107,108 includes a renderer 120,121,122 for presenting the programming guide 123,124,125 to the user 103,104,105. A set-top box is an example renderer. If the client device 106,107,108 does not possess a fresh copy of the program guide 123,124,125 in its local cache, the client device 106,107,108 signals server complex 102 for the program guide 123,124,125. When this occurs, server complex 102 signals client device 106,107,108 with the program guide 123,124,125 requested.

In one embodiment, the signal from client device 106,107,108 for the program guide 123,124,125 also serves as an implicit signal that a navigation event has occurred. If, for example, client device 106 does not already possess a fresh copy of the program guide 123 in its local cache, client device 106 signals server complex 102 that a navigation event has occurred. Client device 106 may choose to signal a navigation event for every movement of a highlight indicator on the currently rendered tier of its program guide 123. Alternatively, client device 106 may choose to signal a navigation event only when a different tier of the program guide 123 is to be rendered.

Server 110 of server complex 102 handles the signals from the client devices 106,107,108. In one embodiment, in response to a signal for program guide 123,124,125, server complex 102 may provide the program guides 123,124,125 without assistance from any other component. In another embodiment, server complex 102 may solicit assistance from the navigation data consumer 126. Assistance from a database 119 may be solicited in real-time or in a prior batch mode, with server complex 102 signaling navigation data consumer 126 for necessary data, with database 119 signaling server 110 of server complex 102 with the necessary data.

A navigation event monitor 111, operable with a control circuit 127 of the server 110, then records the occurrence of the navigation event. This recording can occur from either implicit signals or explicit signals received by server complex 102 from the client devices 106,107,108. A navigation event aggregator 113, also operable with the control circuit 127, aggregates the navigation events recorded by the navigation event monitor 111. In one optional embodiment, the navigation event aggregator 113 optionally signals the navigation data consumer 126 with the aggregated navigation events data.

The database 119, in one embodiment, serves as a source for the program guide 123,124,125 that is processed by server complex 102. This data may include elements of the program guide 123,124,125, tiers of the program guide 123,124,125, or layout or formatting of the program guide 123,124,125. In another embodiment, this data also includes authorization and entitlement data for a particular instantiation of client device 106,107,108. The server complex 102 can optionally provide navigation data to the navigation data consumer 126, for informational purposes, system improvement purposes, economic purposes, or combinations thereof.

In one illustrative embodiment, server 110 requests and receives from the database 119 a catalog of all program guides 123,124,125 that are applicable to all instantiations of client devices 106,107,108. The following steps can then occur repeatedly. Moreover, iterations of these steps may run in parallel and may overlap. All iterations of these steps can commence after the server 110 completes the request and receipt of the catalog in one embodiment.

In one embodiment, the client device 106,107,108 is requested to render a predefined tier of the program guide 123,124,125. For example, client device 106 may request that the second page of title listings for a particular category of video on demand assets 109 be rendered. When this occurs, client device 106 determines the directive is for a particular tier of its program guide 123.

In one embodiment, client device 106 requests the title listing data for the tier from server complex 102. Server complex 102 identifies the requested page as a predefined tier within the program guide 123.

Server complex 102 obtains, from database 119, information for the requested tier. For example, in a video on demand environment, the information may be the purchase status of each element title for the tier corresponding to a particular instantiation of client device 106,107,108. Server complex 102 prepares the navigation title listing data for the requested tier of the program guide 123 for the particular instantiation of client device 106,107,108, and server complex 102 provides the prepared data to client device 106,107,108.

Navigation event monitor 111 records the navigation event, noting the request for the tier. The request recording can include subdata, including the title listing page, category, identifier of the client device 106,107,108, and the timestamp for reception of the request from client device 106,107,108. The record of the event is persisted in the database 119.

In one or more embodiments, the navigation event aggregator 113 can examine the data recorded by the navigation event monitor 111 and aggregates the data. The aggregated data may indicate, for example, that eighteen instantiations of the client devices 106,107,108 requested a predefined tier of a program guide during the time period of 10:30:00 PM through 11:29:59 PM. In one or more embodiments, the navigation event aggregator 113 can push this data to the navigation data consumer.

In accordance with one embodiment, the control circuit 127 of the server 110 of server complex 102 can be configured to execute a method for monitoring navigation events from the traversal of tiers of program guides 123,124,125 by one or more users 103,104,105. The navigation event monitor 111 can perform monitoring in real time. This monitoring can occur in conjunction with the creation of the navigation event responses. The navigation event monitor 111 observes the creation of the response and captures the created response.

In one or more embodiments, data can be derived from the analysis performed by the navigation event aggregator 113. This data can persist in the database 119, and can be accessible by the navigation event monitor 111 and the navigation event aggregator 113. The data can include a timestamp of the date and time the real-time analysis is commenced, the unique identifier of the client device 106,107,108, and the status of the handling of the request by the server 110 of the server complex 102, i.e., either the request was handled as a “success” or a “failure”. Where the server 110 handled the request successfully, the data can include a proprietary, unique identifier for the program guide data that is sent. Additionally, a one-to-one mapping exists between the identifier and the bit stream comprising the program guide data that is sent. Where the server 110 had a failure in handling the request, the data can include a proprietary code identifying the reason for the failure in the handling of the request.

In one or more embodiments, as the user-specific program guide is created, information related to that user-specific program guide can be stored in the database 119 as well. Examples of this information include the type of data in the user-specific program guide, e.g., lists of services, lists of categories, lists of titles, detailed information for a title, and so forth. Alternatively, the information can include a list of the type-specific entities, e.g., the service names, the category names, the title names, the detailed title information, etc. The navigation event aggregator 113 can provide representational state transfer (REST) web services that can be called to obtain metrics corresponding for the navigation program guide response data that is persisted in the database 119 as well.

In one embodiment, the control circuit 127 of the server complex 102 can be configured to modify and customize program guides based upon user navigation data. For example, in one embodiment, the control circuit 127 is configured to initially deliver a universal program guide 114 to all client devices 106,107,108. As noted above, the universal program guide 114 comprises a plurality of predefined tiers in one or more embodiments.

The control circuit 127, working in tandem with the navigation event monitor 111, can monitor a navigation path through at least two of the predefined tiers. For example, if a user 103 starts at a home tier of the universal program guide 114 that presents genres of video on demand assets 109, the user 103 may selection “action,” which leads to a second tier of the universal program guide 114. The navigation event monitor 111 detects this selection as one step in a navigation path.

In one or more embodiments, the navigation event monitor can also determine a navigation duration occurring at each tier. For example, if the user 103 stays at the home tier for thirty seconds, and then stays at the second tier for forty-five seconds before making a selection, this information can be recorded. The information can then be aggregated by the navigation event aggregator 113.

In one embodiment, the control circuit 127 can use the information from the navigation event aggregator 113 to create a unique program guide, e.g., program guide 123, from the navigation path and the navigation duration for the user 103. The control circuit 127 can be configured to deliver the unique program guide to the client device 106 for subsequent presentation.

In a video on demand environment, at least one of the tiers of the universal program guide 114 comprises a listing of video-on-demand titles. In one embodiment, at least one of the tiers of the universal program guide 114 comprises a listing of video-on-demand titles arranged alphabetically in the universal program guide 114. In one embodiment, at least one of the tiers of the universal program guide 114 comprises a listing of video-on-demand titles listed categorically in the universal program guide 114.

When the user-specific or unique program guide is created, in one or more embodiments it will have a different number of tiers from the universal program guide 114. For example, while the universal program guide 114 may have included an alphabetical listing of content offerings, the unique program guide created for user 103 may include a categorical listing of content offerings. In one or more embodiments, promotional offers or content being promoted can be inserted into the unique program guide. Accordingly, the unique program guide can comprise at least one tier not in the navigation path detected through the universal program guide 114 as detected by the navigation event monitor 111. In one embodiment, the unique program guide will have fewer tiers than the universal program guide. Examples of these embodiments will be described in more detail in subsequent figures.

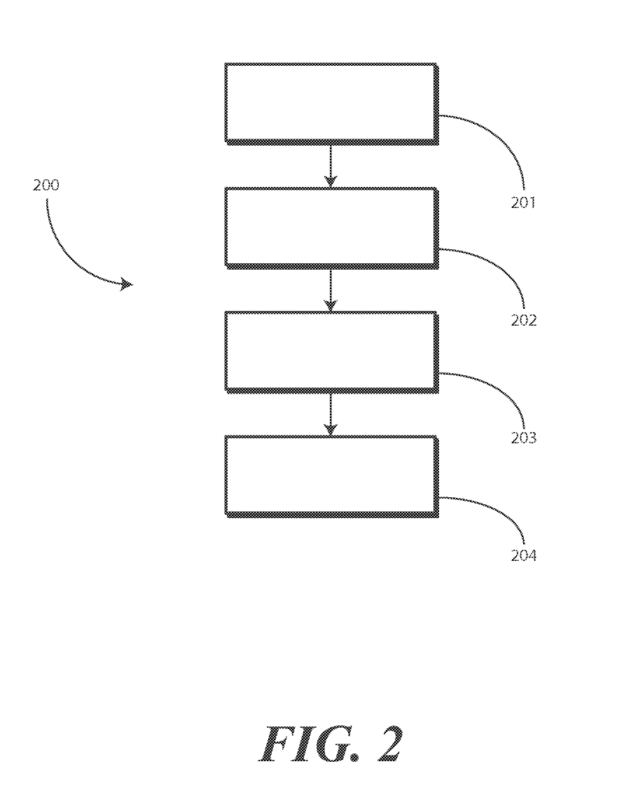

Turning now to FIG. 2, illustrated therein is one method 200 for delivering a program guide configured in accordance with one or more embodiments of the disclosure. The method steps shown in FIG. 2, in one embodiment, correspond to some of the functions of the server complex (102) described above because the method steps are suitable for coding as executable instructions capable of execution by the control circuit (127) and other components of the server complex (102) to effect the steps of the method. In a video on demand environment, the method 200 can be used to deliver a video on demand program guide.

At step 201, the method 200 delivers a predefined program guide to a client device of a user. In one embodiment, the predefined program guide is a universal program guide that is delivered generally to all client devices at least initially. In one embodiment, the predefined program guide comprises a plurality of tiers.

At step 202, the method 200 monitors a navigation path of the user on the client device through at least some of the plurality of selection tiers. In one embodiment, step 202 includes determining a selection terminating the navigation path. Such a selection may be content or a video on demand asset that a user selects for viewing. At step 203, the method 200 also monitors a navigation duration at each tier selected by the user.

At step 203, the method 200 creates a user-specific program guide as a function of the navigation path and the navigation duration. Examples of user-specific program guides will be shown in explanatory embodiments of subsequent figures. In one embodiment, the user-specific program guide comprises a predefined start tier that is not a function of the navigation path or the navigation duration. For example, a purveyor of a system employing the method 200 may want all users to see the same “start page” of the program guide. Accordingly, even if the user-specific program guide is customized for the user based upon navigation events and/or durations, the start page may not be a function of this data. It may instead be selected independent of any monitored navigation events or durations.

In a similar fashion, in one embodiment, at least one sub tier of the user-specific program guide may comprise a predefined tier that is not a function of the navigation path or the navigation duration. For example, the purveyor may want a particular user to see at least one promotional tier during navigation of the user-specific program guide. Accordingly, they may insert such a tier in the user-specific program guide. In such an embodiment, at least one sub tier can comprise a predefined category of promotional content titles.

In one embodiment, to enhance the user experience, e.g., make the user's navigational path shorter, step 203 includes creating the user-specific program guide to have fewer tiers than the predefined program guide. For example, in one embodiment the predefined program guide may comprise an alphabetical listing of content titles, while the user-specific program guide may comprise a category corresponding to the selection. The latter will result in a lesser number of tiers in many embodiments.

Where step 202 includes determining a selection terminating the navigation path, step 203 can include adding the termination point of the navigation path to the user-specific program guide. For example, if a user selects an action movie as the termination point, step 302 can include adding at least that selection to the user-specific program guide. At step 204, the method 200 delivers the user-specific program guide to the client device during a next user interaction with the client device.

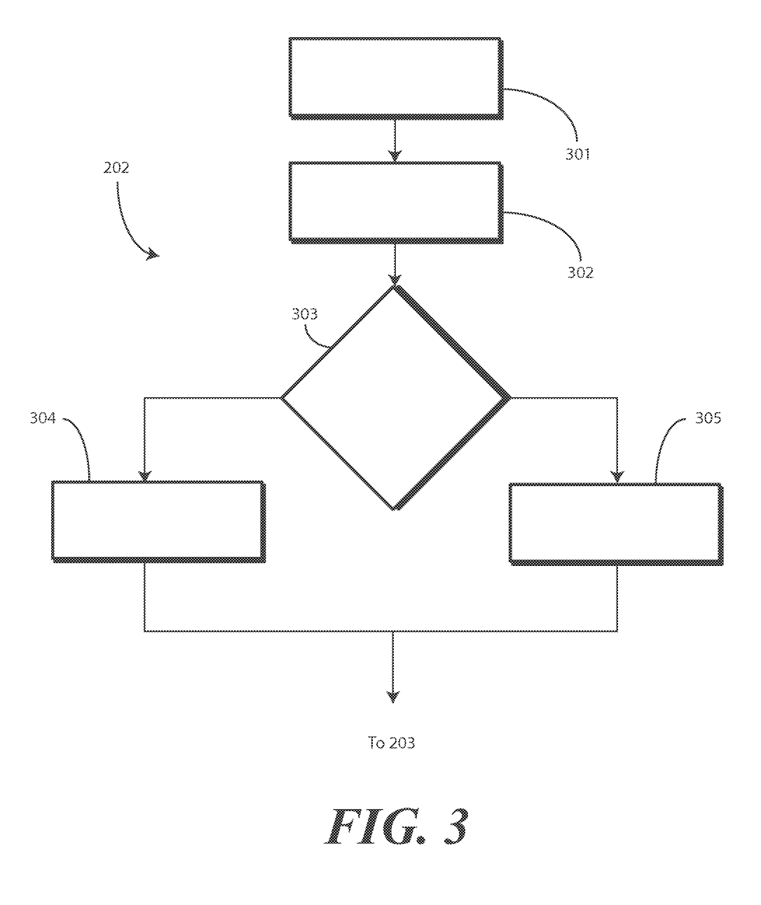

Step 202, the monitoring step, can include many optional substeps. Turning now to FIG. 3, illustrated therein are some of the sub-steps. Beginning at step 301, step 202 can include recording a time stamp when the monitoring commences. At step 302, step 202 can include detecting a unique identifier of the client device.

At decision 303, step 202 can include determining whether the monitoring was successful. Where it is, step 304 can include associating results of the monitoring with the unique identifier. Where it is not, step 305 can include transmitting a monitoring fail signal to the client device. Step 305 can also include recording a failure code in the server.

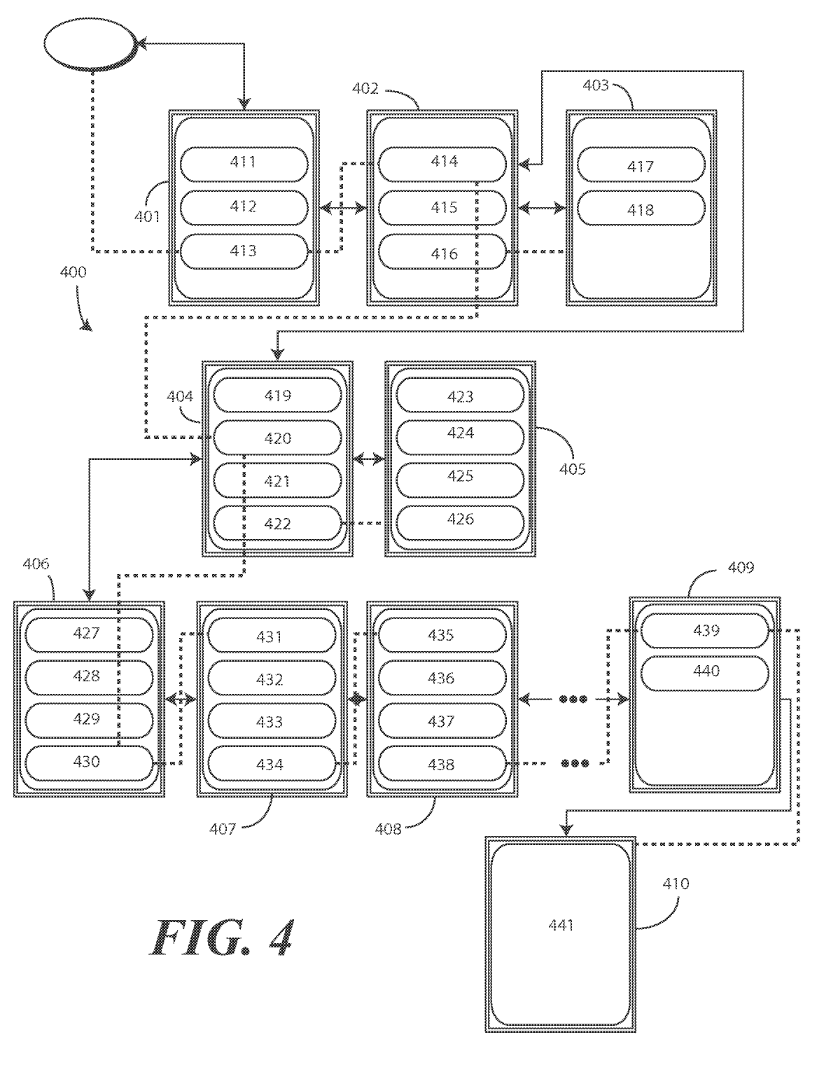

Turning now to FIGS. 4-6, illustrated therein are examples of systems and methods configured in accordance with one or more embodiments of the disclosure in operation. Beginning with FIG. 4, illustrated therein is an example of a universal program guide 400. As briefly alluded to above, in one or more embodiments a program guide can include a plurality of tiers. Explanatory tiers 401,402,403,404,405,406,407,408,409,410 are shown. The tiers 401,402,403,404,405,406,407,408,409,410 can present pages of category listings, subcategory listings, title listings, and so forth. The numbers of tiers and selectable items shown are for illustrative purposes only, as many other configurations of the program guide will be obvious to those of ordinary skill in the art having the benefit of this disclosure.

In FIG. 4, explanatory tiers 401,402,403,404,405,406,407,408,409,410 are shown. Tier 401 includes three selectable items 411,412,413. Selectable item 411 may be “news,” while selectable item 412 is “sports,” and selectable item 413 is “more.” When a user selects selectable item 413, they are taken to the second tier 402, which includes three additional selectable items 414,415,416. Selectable item 414 may be “movies,” while selectable item 415 is “help,” and selectable item 416 is “more.” Selecting selectable item 416 takes the user to tier 403, which in this illustrative embodiment includes two selectable items 417,418. Selectable item 417 is “premium movies,” while selectable item 418 is “rented movies.”

When selecting selectable item 414, tier 404 is called. In this illustrative embodiment, tier 404 includes four selectable items 419,420,421,422. Selectable item 419 may be “new movies,” while selectable item 420 depicts “A-Z,” indicating that an alphabetical list of movies can be accessed when this selectable item 420 is chosen. Selectable item 421 may be “free movies,” while selectable item 422 may be another “more” item. For example, selecting selectable item 422 may reveal tier 405, which has four selectable items 423,424,425,426. Selectable item 423 may be “action movies,” while selectable item 424 may be “dramatic movies.” Selectable item 425 may be “family movies,” while selectable item 426 may be “romantic movies,” and so forth.

Selecting selectable item 420 may lead to the first list of alphabetically listed movies set forth on tier 406. Selectable item 427 may be the movie “Allen,” while selectable item 428 is “Amadeus.” Selectable item 428 may be “Amarcord,” while selectable item 430 is another “more” selection. Tiers 407,408,409 may show similar listings. Selectable item 431 may be “Babe,” while selectable item 432 is “Babel.” Selectable item 433 may be “Batman,” while selectable item 434 is another “more” selection. Similarly, selectable item 435 may be “Brazil,” while selectable item 436 is “Casino.” Selectable item 437 may be “Contempt,” while selectable item 438 is another “more” selection. Moving to the end of the list, selectable item 439 may be “Vertigo” while selectable item 440 is “Z.” Selecting selectable item 440 reveals tier 410, which includes information 441 about the movie “Z.”

In one embodiment, tier 401 is presented first. A user may select a selectable item on that tier 401 or navigate to another tier with selectable item 413. If the user selects selectable item 414, a series of one or more selectable items 419,420,421 representing categories can be presented at tier 404. Again, the user may select a selectable item 419,420,421 at this tier or navigate to another tier with selectable item 422. If the user selects selectable item 420, tiers 406,407,408,409 can be presented, with tier 406 being presented first, and other tiers 407,408,409 being presented depending upon various user selections. In these tiers 406,407,408,409 any number of titles can be arranged alphabetically across tiers 406,407,408,409. In this type of program guide 400, the only way for the user to navigate to a later tier in the set is to navigate serially through all earlier tiers in the set.

As users navigate the universal program guide 400, an identification of every tier that was visited by each user, i.e., a navigation path, and a timestamp for the navigation duration at each tier, can be stored in a database (119) and/or persisted on a server (110). Because the tiered structure of the universal program guide 400 is known by the server (110), it is possible to determine both the actual navigation path and the direct, tiered navigation path of each user through the universal program guide 400, as well as the navigation duration at each tier for both paths. For example, if the time-based sequence for a particular user is the following:

13:28 Tier 401

13:30 Tier 402

13:31 Tier 404

13:33 Tier 405

13:36 Tier 404

13:39 Tier 406

13:42 Tier 407

. . .

14:03 Tier 409

14:04 Tier 410
then the actual navigation path and the time of visitation of each tier for this user are determined to be the following:
Tier 401 to Tier 402 to Tier 404 to Tier 405 to Tier 404 to Tier 406 to Tier 407 . . . to Tier 409 to Tier 410; with durations:
Tier 401-2 seconds;
Tier 402-1 second;
Tier 404-2 seconds;
Tier 405-3 seconds;
Tier 404-3 seconds;
Tier 406-3 seconds;
Tier 407-21 seconds; and
Tier 409-1 second.
Moreover, the direct, tiered navigation path can be inferred to be:
Tier 402 to Tier 404 to Tier 409 to Tier 410; with durations:
Tier 402-3 seconds;
Tier 404-8 seconds; and
Tier 409-24 seconds.

Aggregation for all users can be determined as well. Presume that the actual direct navigation paths, the direct, tiered navigation paths, and the page visitation duration times are determined for all users. For example:
Tier 401: visited 583 times for 934 seconds in actual navigation;

visited 86 times for 137 seconds in direct, tiered navigation;
Tier 402: visited 474 times for 528 seconds in actual navigation;

visited 237 times for 451 seconds in direct, tiered navigation;
Tier 403: visited 37 times for 52 seconds in actual navigation;

visited 28 times for 43 seconds in direct, tiered navigation;
Tier 406: visited 113 times for 140 seconds in actual navigation;

visited 5 times for 14 seconds in direct, tiered navigation;
Tier 407: visited 38 times for 52 seconds in actual navigation; and

visited 31 times for 43 seconds in direct, tiered navigation.

The server (110) can then create unique program guides using this explanatory data, as it can be very telling regarding the navigation experiences of the users. For example, the server (110) can make the following observations: All users were compelled to visit tier 401, even though most users opted not to navigate deeper from tier 401. Most users chose to navigate deeper from tier 402 without even considering the possibility of choices from tier 403. Said differently, few users even viewed content revealed by selectable item 417. All users navigating through the selectable item 420 were compelled to visit tier 406, even though most users opted not to select a selectable item at this tier 406. Most users navigating through selectable item 420 had a yearning to watch the content described at information 441. However, the users were forced to navigate through nineteen consecutive tiers before selectable item 440 was revealed. Those of ordinary skill in the art having the benefit of this disclosure will understand that the “nineteen” tiers in this example represent an illustrative number of tiers for explanatory purposes only. Other numbers of tiers could be used without departing from the spirit and scope of the disclosure.

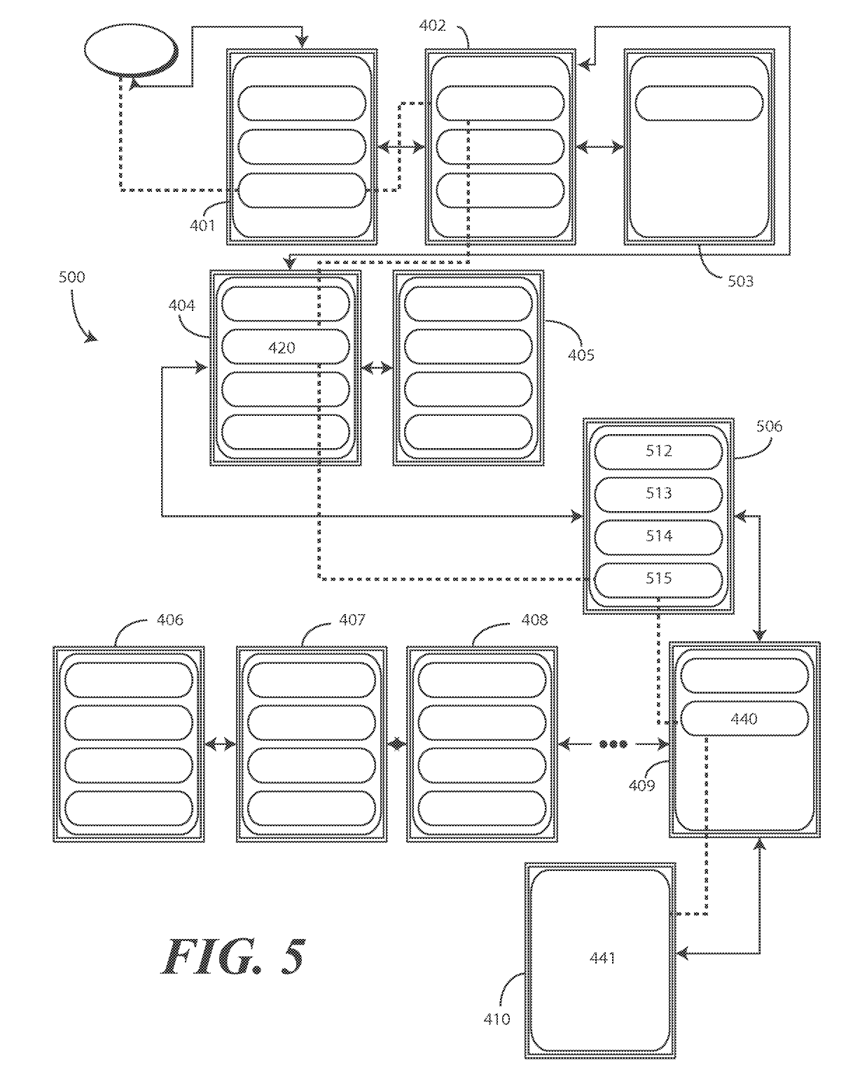

With this data, decisions are made to create a unique and/or user-specific program guide that adjusts the tiered navigation menus according to particular desires. As noted above, in one embodiment the unique and/or user-specific program guide has a different number, perhaps fewer, tiers that the universal program guide 400. Accordingly, if the desire is to minimize the number of navigation steps needed to reach the most popular title listings, navigation paths can be altered. Turning now to FIG. 5, illustrated therein is one example.

FIG. 5 illustrates an explanatory embodiment of a unique and/or user-specific program guide 500. Explanatory tiers 401,402,503,404,405,506,406,407,408,409,410 are shown. The tiers 401,402,503,404,405,406,407,408,409,410 can present pages of category listings, subcategory listings, title listings, and so forth. Many of the tiers 401,402,404,405,406,407,408,409,410 of this illustrative embodiment are common with the universal program guide (400) of FIG. 4. However, in one embodiment, at least some of the tiers, e.g., tier 503 and tier 506, will be different from tiers, e.g., tier (403) and tier (406) of FIG. 4.

In this illustrative embodiment, rather than navigating through nineteen different pages before selectable item 440 was revealed, tier 506 provides four new selectable items 512,513,514,515. Tier 503 is revealed when selectable item 420 is selected.

In this embodiment, selectable item 512 is an “A through E” selector, while selectable item 513 is an “F through L” selector. Similarly, selectable item 514 is an “M through T” selector, while selectable item 515 is a “U through Z” selector. Accordingly, a user desiring to see the movie “Z” can select selectable item 515 to reveal tier 409. Selecting selectable item selectable item 440 reveals tier 410, which includes information 441 about the movie “Z.”

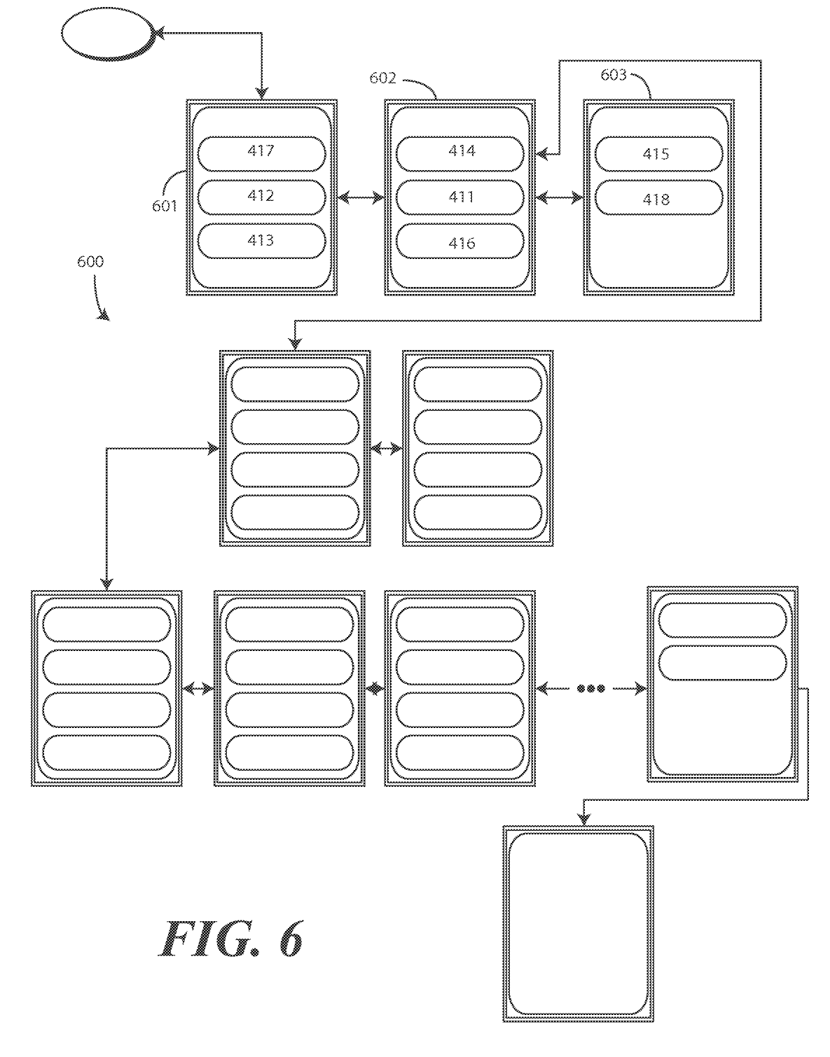

If a purveyor of methods or systems wants to promote particular categories, navigation paths can also be altered. Turning now to FIG. 6, illustrated therein is an example of a unique program guide 600 where at least one sub tier comprises a predefined tier that is not a function of the navigation path or the navigation duration, and is instead a predefined category of promotional content titles.

In unique program guide 600, the purveyor wishes to promote premium movies. Accordingly, tiers 601,602,603 replace tiers (401,402,403) of FIG. 4. Tier 601 includes three selectable items 417,412,413. Selectable item 417 is “premium movies,” and has been moved to the start page so that every user must see it. Selectable item 411 is “news,” and has been moved to tier 602 to provide space on tier 601.

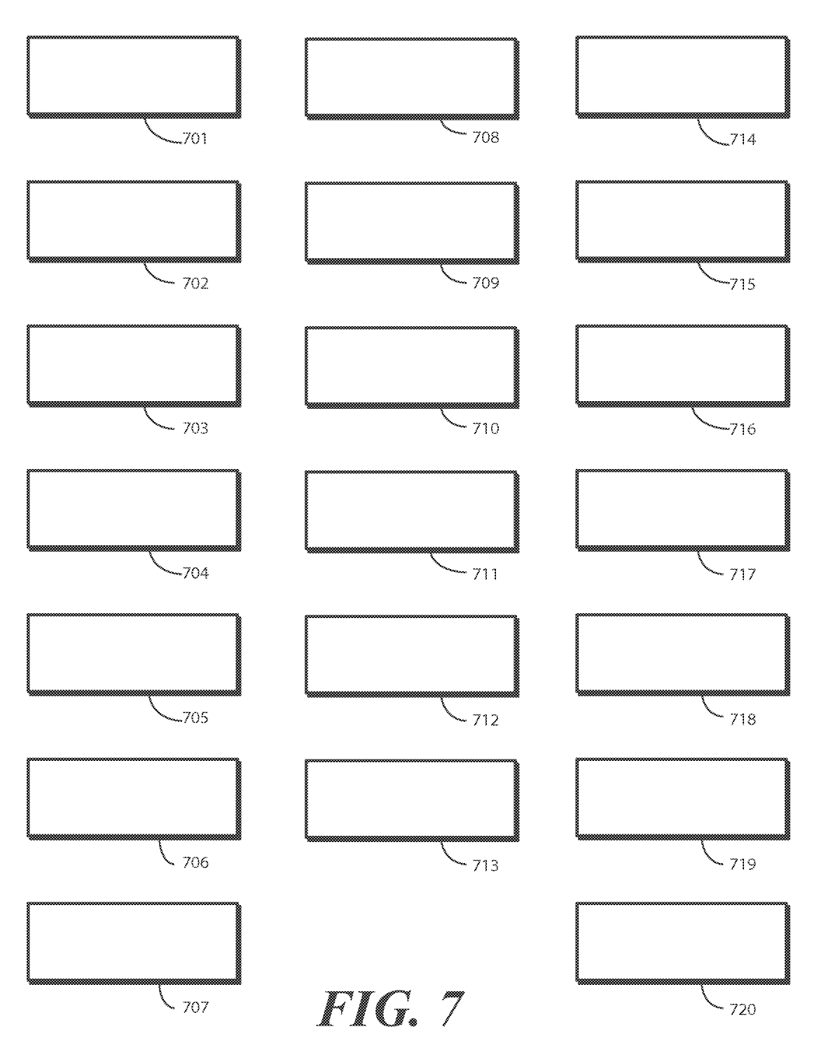

Turning now to FIG. 7, illustrated therein are various embodiments of the disclosure. At 701, a method for providing a video on demand program guide comprises delivering, from a server, a predefined program guide to a client device of a user, the predefined program guide comprising a plurality of tiers; monitoring, with the server, a navigation path of the user on the client device through at least some of the plurality of selection tiers; also monitoring, with the server, a navigation duration at each tier selected by the user; creating a user-specific program guide as a function of the navigation path and the navigation duration; and delivering the user-specific program guide to the client device during a next user interaction with the client device. At 702, 701 includes recording a time stamp when the monitoring commences. At 703, 702 includes detecting a unique identifier of the client device.

At 704, 703 includes determining whether the monitoring was successful, and if not, transmitting a monitoring fail signal to the client device. At 705, 704 includes recording a failure code in the server. At 706, 703 includes determining whether the monitoring was successful, and if so, associating results of the monitoring and the also monitoring with the unique identifier.

At 707, the user-specific program guide of 701 includes a predefined start tier that is not a function of the navigation path or the navigation duration. AT 708, at least one sub tier of 701 includes a predefined tier that is not a function of the navigation path or the navigation duration. At 709, the at least one sub tier of 708 includes a predefined category of promotional content titles.

At 710, the user-specific program guide of 701 includes fewer tiers than the predefined program guide. At 711, the monitoring of 701 includes determining a selection terminating the navigation path. At 712, the user-specific program guide of 711 includes the selection. At 713, the predefined program guide of 711 includes an alphabetical listing of content titles, the user-specific program guide comprising a category corresponding to the selection.

At 714 a server comprises a control circuit in communication with a client device, the control circuit to: deliver a universal program guide to the client device, the universal program guide comprising a plurality of predefined tiers; monitor a navigation path through at least two of the predefined tiers; determine a navigation duration occurring at each tier; create a unique program guide from the navigation path and the navigation duration; and deliver the unique program guide to the client device for subsequent presentation. At 715, the universal program guide of 714 comprises a listing of video-on-demand titles. At 716, the listing of video-on-demand titles of 714 is listed alphabetically in the universal program guide.

At 717, the listing of video-on-demand titles at 716 is listed categorically in the unique program guide. At 718, the unique program guide of 714 includes a different plurality of tiers. At 719, the unique program guide of 718 includes at least one tier not in the navigation path. At 720, the unique program guide of 718 has fewer tiers than the universal program guide.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A method for providing a video on demand (VOD) program guide comprising:
delivering, from a server, a predefined program guide to a client device of a user, the predefined program guide comprising a plurality of tiers;
monitoring, with the server, a navigation path of the user on the client device through at least some of the plurality of tiers;
also monitoring, with the server, a navigation duration at each tier selected by the user;
creating a user-specific program guide as a function of the navigation path and the navigation duration; and
delivering the user-specific program guide to the client device during a next user interaction with the client device;
the user-specific program guide having fewer tiers than the predefined program guide.

2. The method of claim 1, further comprising recording a time stamp when the monitoring commences.

3. The method of claim 2, further comprising detecting a unique identifier of the client device.

4. The method of claim 3, further comprising determining whether the monitoring was successful, and if not, transmitting a monitoring fail signal to the client device.

5. The method of claim 4, further comprising recording a failure code in the server.

6. The method of claim 3, further comprising determining whether the monitoring was successful, and if so, associating results of the monitoring with the unique identifier.

7. The method of claim 1, the user-specific program guide comprising a predefined start tier that is not a function of the navigation path or the navigation duration.

8. The method of claim 1, at least one sub tier comprising a predefined tier that is not a function of the navigation path or the navigation duration.

9. The method of claim 8, at least one sub tier comprising a predefined category of promotional content titles.

10. (canceled)

11. The method of claim 1, the monitoring comprising determining a selection terminating the navigation path.

12. The method of claim 11, the user-specific program guide comprising the selection.

13. The method of claim 11, the predefined program guide comprising an alphabetical listing of content titles, the user-specific program guide comprising a category corresponding to the selection.

14. A server, the server comprising:
a control circuit in communication with a client device, the control circuit to:
deliver a universal program guide to the client device, the universal program guide comprising a plurality of predefined tiers;
monitor a navigation path through at least two predefined tiers;
determine a navigation duration occurring at each tier;
create a unique program guide from the navigation path and the navigation duration; and
deliver the unique program guide to the client device for subsequent presentation;
the unique program guide having fewer tiers than the universal program guide.

15. The server of claim 14, the universal program guide comprising a listing of video-on-demand titles.

16. The server of claim 15, the listing of video-on-demand titles listed alphabetically in the universal program guide.

17. The server of claim 16, the listing of video-on-demand titles listed categorically in the unique program guide.

18. The server of claim 14, the unique program guide comprising a different plurality of tiers.

19. The server of claim 18, the unique program guide comprising at least one tier not in the navigation path.

20. (canceled)
